(19) United States
(12) Patent Application Publication
(10) Pub. No.: US 2014/0242289 A1
(43) Pub. Date: Aug. 28, 2014

(54) METHOD FOR FORMING TITANIUM OXIDE FILM ON SURFACE OF MOLDED PRODUCT COMPOSED OF GLASS

(71) Applicant: USHIO DENKI KABUSHIKI KAISHA, Tokyo (JP)

(72) Inventors: Kinichi Morita, Tokyo (JP); Toshikazu Kawaguchi, Hokkaido (JP); Katsuaki Shimazu, Hokkaido (JP); Tadao Kimijima, Tochigi (JP)

(73) Assignee: USHIO DENKI KABUSHIKI KAISHA, Tokyo (JP)

(21) Appl. No.: 14/190,868

(22) Filed: Feb. 26, 2014

(30) Foreign Application Priority Data
Feb. 26, 2013 (JP) 2013-035578

(51) Int. Cl. B05D 1/18

(52) U.S. Cl. CPC B05D 1/18
USPC 427/443.2

(57) ABSTRACT

In a method for forming a titanium oxide film, with which a titanium oxide film can be formed on a surface of a glass base material, a surface of a molded product composed of a glass is irradiated with ultraviolet light in an air atmosphere in step 0. In Step 1, the base material is immersed in a mixed liquid of an aqueous solution of titanium chloride and a nitrite ion-containing aqueous solution. As a result of the immersion, a titanium oxide film is grown by repeating oxidation of a titanium ion, binding of the oxidized titanium ion to oxygen, and binding of the bound oxygen to a titanium ion at the cleaved end of the glass molded product. In Step 2, the base material is pulled out from the mixed liquid, and then washed to stop the reaction. The film thickness can be controlled by controlling the immersion time.

### BACKGROUND OF THE INVENTION

1. Field of the Invention

The present invention relates to a method for forming a titanium oxide film on a surface of a molded product composed of a glass.

2. Background Art

Heretofore, titanium oxide exhibiting a high refractive index and having excellent chemical stability has been used in various industrial fields.

Titanium oxide is classified based on the crystal structure into rutile type, anatase type, and brookite type, however, actually industrially used titanium oxide is rutile type and anatase type.

Titanium oxide has a high refractive index and a high light scattering property, and therefore, when it is in a powder state, it becomes a white powder. Titanium oxide in such a powder state is used in a large amount as a white pigment in paints, plastics, papers, inks, etc. In particular, titanium oxide having a rutile crystal structure with high thermal stability (hereinafter referred to as “rutile-type titanium oxide”) has a stable crystal structure, high thermal stability, and high light-shielding ability, and therefore is used as a white pigment material for paints. Further, for example, rutile-type titanium oxide having a particle diameter of 0.1 μm or less has high transmittance of visible light, but has low transmittance of ultraviolet light, and therefore is often blended in sunscreen cosmetics, etc.

On the other hand, titanium oxide is an effective photocatalytically active substance, and therefore is used as a photocatalyst in various industrial fields. At present, there is no substance adopted as a photocatalyst for practical use other than titanium oxide.

In particular, titanium oxide having an anatase crystal structure (hereinafter referred to as “anatase-type titanium oxide”) has higher reducing ability and has characteristics to exhibit higher photocatalytic activity than rutile-type titanium oxide. Accordingly, in general, anatase-type titanium oxide is often used as a photocatalyst.

Anatase-type titanium oxide has a wide band gap and exhibits photocatalytic activity only when it is irradiated with ultraviolet light with a wavelength of about 380 nm or less corresponding to the band gap. For example, when anatase-type titanium oxide absorbs ultraviolet light with a wavelength of about 380 nm or less in the air, it oxidatively decomposes an organic substance or the like located in contact with or in the vicinity of the surface of the anatase-type titanium oxide.

Further, when anatase-type titanium oxide is irradiated with the above-described ultraviolet light, it exhibits superhydrophilic activity such that the contact angle of water on the surface thereof is 5° or less.

Therefore, by retaining titanium oxide on the surface of a base material, a photocatalytic function is imparted to the surface of the base material, and further, the surface becomes a hydrophilic surface. A base material in which such a photocatalytic function is imparted to the surface thereof is used in the antibacterial, deodorant, and antifouling fields, etc.

As one of the base materials in which titanium oxide is retained on the surface thereof, a glass is widely used.

For example, if a titanium oxide coating is applied to automobile mirrors, road mirrors, automobile windshields, etc., since the mirror surface is hydrophilic, water adhering to the surface does not turn into droplets, and a dirt on the mirror surface is washed off, and thus, visibility in the rain is improved. That is, by the titanium oxide coating on a glass, an antifogging effect and an antifouling effect on the glass can be obtained. Further, since a photocatalytic function is imparted to the surface, even if an organic impurity such as an oil is adhered thereto, the organic substance is decomposed by irradiating the surface with ultraviolet light during the day. Further, the titanium oxide film on the glass also exhibits a UV-shielding effect, and therefore, when titanium oxide coating is applied to an automobile windshield, it is not necessary to attach a UV-shielding film which prevents the penetration of ultraviolet light inside the car to the windshield.

As described above, when titanium oxide is used as a photocatalyst in industry, a photocatalytic function is generally imparted to a surface of a base material by fixing the above-described titanium oxide to the surface of the base material. In the fixation of titanium oxide to the base material, a wet process in which a coating agent containing titanium oxide is used or a dry process in which a titanium oxide film is formed in vacuum is adopted.

At present, a wet process is used in a relatively wide range, and as a starting material for fixing titanium oxide to a base material in a wet process, generally, a titanium oxide powder, a titanium oxide sol obtained by dispersing titanium oxide fine particles having a size of about 10 nm in water or a solvent, or a titanium compound such as a titanium alkoxide which is a precursor of titanium oxide is used. Incidentally, the above-described titanium oxide powder is used by dispersing it in a solvent, however, the resulting dispersion has a problem that when it is applied, it is easily turned into white. Therefore, in a wet process, generally, a titanium oxide sol in which titanium oxide, which is fine to such an extent that light is not scattered, is dispersed without aggregating or a titanium compound such as a titanium alkoxide is often adopted.

The fixation of titanium oxide to a base material is performed, for example, as follows.

In the case of a titanium oxide sol, first, a titanium oxide sol is applied to a surface of a base material to which a photocatalytic function is imparted. Then, the sol is dried at a high temperature, whereby a titanium oxide film is obtained on the surface of the base material.

In the case of using a titanium compound, first, for example, a titanium alkoxide such as titanium isopropoxide is dissolved in an alcohol solvent to effect hydrolysis, whereby a titania sol in which fine particles of a hydroxide of titanium are dissolved is formed. The thus formed titania sol is applied to a surface of a base material to which a photocatalytic function is imparted, followed by firing at a temperature of, for example, about 600° C. or lower, whereby a titanium oxide film is obtained on the surface of the base material. A similar example is described in Japanese Patent Application Publication No. JP-A-2001-262008.

Incidentally, the usage examples of a titanium compound vary. For example, Japanese Patent Application Publication No. JP-A-2011-195798 discloses an example in which titanium hydroxide obtained by hydrolyzing a halide of titanium is dissolved in an aqueous solution of a strong organic base, and further a hydroxide polymer is added thereto, and the resulting material is used.

In the case where titanium oxide is fixed to a base material having low thermal resistance, a method in which a coating material containing titanium oxide fine particles and a curable binder (a coating agent obtained by adding a binder to a titanium oxide sol) is applied to a base material, and titanium oxide is fixed to the surface of the base material by utilizing the curing of the binder is generally used. Incidentally, an organic binder which has been conventionally used in a paint causes deterioration such as chalking in a short time due to the high oxidative ability of photocatalytic titanium oxide, and therefore, in order to design the composition of a photocatalytic coating material, an inorganic binder which is resistant to oxidation is used. An example of using such a binder is disclosed in, for example, Japanese Patent Application Publication No. JP-A-2003-105262.

Incidentally, as the dry process, various methods such as vapor deposition, sputtering, ion beam mixing, ion implantation, and CVD are used at present. Further, a study of a dry process using a thermal spraying method in which film formation is performed in the air has been also performed.

Further, recently, a thin-film production process using an anodization method utilizing an electrochemical reaction in an aqueous solution or a liquid-phase deposition (LPD) method utilizing a chemical reaction in an aqueous solution is also performed. For example, Japanese Patent No. 2785433 discloses a process in which a base material is immersed in an aqueous solution, in which ammonium fluorotitanate or titanium hydrofluoride is contained and boric acid or aluminum chloride for supplementing fluorine ions is added, whereby a titanium oxide film is formed on a surface of the base material. Further, Japanese Patent Application Publication No. JP-A-10-139482 discloses a process in which a base material is immersed in an aqueous solution of titanyl sulfate, whereby a titanium oxide film is formed on a surface of the base material by hydrolysis of titanyl sulfate.

As described above, in the case where titanium oxide is fixed to a surface of a base material by a wet process, the process includes: an application step in which a titanium oxide coating agent such as a titanium oxide sol or a titanium compound such as a titanium alkoxide is applied to a surface of a base material; and a firing step in which the titanium oxide coating agent is fired along with the base material having the titanium oxide coating agent applied thereto to form a film of crystallized titanium oxide on the surface of the base material. In particular, in the case of using a titanium alkoxide, before the application step, a titania sol forming step in which fine particles of a hydroxide of titanium are dissolved, thereby forming a titania sol is needed.

That is, in a method for fixing titanium oxide as described above, the steps are complicated.

Further, as described above, a firing step is needed, and therefore, the base material to which titanium oxide is fixed is required to have thermal resistance.

On the other hand, in the case where it is necessary to use a base material having low thermal resistance, as described above, a coating agent obtained by adding a binder to a titanium oxide sol is applied to a base material, and titanium oxide is fixed to the surface of the base material by curing the binder. This method enables the fixation of titanium oxide to a base material having low thermal resistance, but has a problem that since a large amount of the inorganic binder is used for improving the adhesiveness of titanium oxide to a base material, the photocatalytic activity is deteriorated.

In the case where titanium oxide is fixed to a surface of a glass base material by a wet process, a titanium oxide film is fixed by physical adsorption. Therefore, the physical adsorption strength of a titanium oxide film on a surface of a glass base material varies depending on the thickness of the titanium oxide film. That is, when a titanium oxide film is formed relatively thick on a glass base material, the titanium oxide film is easily peeled off.

Further, in a wet process, a titanium oxide coating agent is applied to a surface of a base material, however, it is generally difficult to uniformly apply the titanium oxide coating agent to the base material. Therefore, also the thickness of titanium oxide film fixed to the surface of the glass base material is not uniform, and therefore, a UV-shielding effect, an antifogging effect, an antifouling effect, and a photocatalytic effect, which are expected to be imparted to the glass having titanium oxide fixed thereto, are not uniformly exhibited in a region of the glass surface.

On the other hand, in the case where titanium oxide is fixed to a base material by a dry process, a titanium oxide film is formed in vacuum as described above, and therefore, a large-scale film forming apparatus provided with a vacuum unit is needed. Further, in such a film forming process, generally, it is necessary to heat a base material on which a titanium oxide film is formed. Therefore, it is difficult to fix titanium oxide to a base material having low thermal resistance by a dry process. For example, in the case where a titanium oxide film is formed on a base material by a vapor deposition method, a film is formed also in an undesired region of the base material, or it is difficult to control the film thickness, or the film thickness is not always uniform. Further, the process generally has a problem that a film cannot be formed on a base material having a complicated shape other than a plain plate.

In addition, in the case of using a stencil for preventing the formation of a film in an undesired region, a problem arises that the film thickness of a peripheral portion of a region where the film is formed is increased.

The anodization method is a method in which a base material is made the anode, and the anode is oxidized by an electrochemical reaction, whereby an oxide film is formed, and therefore, the base material on which a titanium oxide film is formed is limited to titanium or a titanium alloy.

Further, in the LPD method disclosed in Japanese Patent No. 2785433, it is necessary to use a substance which is difficult to handle and has a safety problem such as ammonium fluorotitanate or titanium hydrofluoride, and moreover, it is necessary to additionally add an agent for supplementing fluorine ions, and therefore, the steps are complicated, and thus, the method has a problem from the viewpoint of practical use. On the other hand, in a film forming process utilizing hydrolysis as disclosed in Japanese Patent Application Publication No. JP-A-10-139482, it is necessary to set the temperature of a solution to a higher temperature than room temperature for accelerating the hydrolysis reaction, and thus, the uniformity of the film thickness is poor due to the effect of convection flow.

### SUMMARY OF THE INVENTION

The present invention has been made in view of the above circumstances, and has an object to provide a method for forming a titanium oxide film on a base material, with which a titanium oxide film can be easily formed on a surface of a base material without resort to a heating step required in a conventional method, and the thickness of the titanium oxide film can be controlled.

According to the method for forming a titanium oxide film of the present invention, titanium oxide can be easily and substantially uniformly fixed to a base material which is a molded product composed particularly of a glass.

As a result of intensive studies made by the present inventors, it was confirmed that by subjecting a base material which is a molded product composed of a glass to the following Step 0 to Step 3 shown in FIG. 1, a titanium oxide film can be formed on the molded product composed of a glass.

(Step 0) A surface of a base material W which is a molded product composed of a glass to which titanium oxide is fixed is irradiated with ultraviolet light from a light source L in an air atmosphere containing oxygen and water.

By doing this, as shown in Step 0 of FIG. 1, a siloxane bond is cleaved on a glass surface, and oxygen (O) bound to silicon (Si) is exposed on the glass surface. This exposed oxygen is bound to hydrogen (H) in water contained in the atmosphere to form a hydroxy group. That is, it is considered that an end group on the glass surface is converted to a hydroxy group in the end.

Incidentally, in fact, as shown in FIG. 1, the glass has an amorphous structure, and silicon atoms and oxygen atoms are irregularly arranged, however, here, in order to facilitate understanding, the structure of the glass surface is assumed to be a siloxane structure in which silicon atoms and oxygen atoms are linearly arranged. Further, as the glass, a silicate glass having a silicon dioxide backbone is taken as an example, however, the glass is not limited thereto. For example, an oxide glass such as a borate glass may be used, and also in the case of such a glass, as a result of Step 0, an end group on the glass surface is considered to be converted to a hydroxy group.

(Step 1) The above base material is immersed in a mixed liquid of an aqueous solution of titanium chloride and a nitrite ion-containing aqueous solution (for example, an aqueous solution of sodium nitrite) (Step 1(a) of FIG. 1).

As a result of the immersion, as shown in Step 1(b) of FIG. 1, hydrogen is removed from the hydroxy end group of the molded product composed of a glass, and oxygen and a titanium ion in the mixed liquid are bound to each other.

Then, a titanium oxide film is grown on the ultraviolet light-irradiated surface of the molded product composed of a glass by repeating oxidation of a titanium ion with a nitrite ion, binding of the oxidized titanium ion to oxygen, and binding of the bound oxygen to a titanium ion at the end of the cleaved siloxane bond on the surface of the glass molded product (Step 1(c) of FIG. 1).

(Step 2) After the lapse of a predetermined time, as shown in Step 2 of FIG. 1, the base material is pulled out from the mixed liquid and washed. That is, by washing with pure water, the reaction is stopped.

The thickness of the titanium oxide film on the base material increases as the immersion time increases, however, by pulling out the base material from the mixed liquid and washing the base material, the reaction of forming the titanium oxide film is stopped. It is considered that by controlling this immersion time, the thickness of the titanium oxide film can be controlled.

(Step 3) The base material after washing is dried at room temperature.

As the light, vacuum ultraviolet light including light with a wavelength of 200 nm or less (preferably light with a wavelength of 180 nm or less), which is absorbed by a glass, and is light with a wavelength having an energy exceeding the activation energy of the glass is irradiated on the surface. More specifically, as described in embodiments below, for example, monochromatic light with a center wavelength of 172 nm emitted from a vacuum ultraviolet excimer lamp is irradiated on the surface.

That is, in the present invention, the above-described object is achieved as follows.

(1) In the method for forming a titanium oxide film on a surface of a molded product composed of a glass, a hydroxy group is introduced on a surface of a molded product composed of a glass and also a reaction inhibitor which remains on the surface and inhibits the formation of a titanium oxide film is removed, and thereafter, the molded product is immersed in a mixed liquid of an aqueous solution of titanium chloride and a nitrite ion-containing aqueous solution.

(2) In the introduction of a hydroxy group and the removal of a reaction inhibitor in the above (1), a surface of a molded product composed of a glass is irradiated with light including vacuum ultraviolet light with a wavelength of 200 nm or less in an air atmosphere containing oxygen and water, and the molded product is immersed in a mixed liquid of an aqueous solution of titanium chloride and a nitrite ion-containing aqueous solution.

(3) In the above (1) or (2), after the lapse of a predetermined time from the initiation of immersion of the molded product in the mixed liquid, the molded product is pulled out from the mixed liquid, washed with water to stop the film forming process, and then, the molded product after washing with water is dried at room temperature.

According to the present invention, the following advantageous effects can be obtained.

(1) Since a titanium oxide film is formed on a surface of a molded product composed of a glass by irradiating a surface of a molded product composed of a glass with light including ultraviolet light with a wavelength of 200 nm or less, and then, immersing the molded product in a mixed liquid of an aqueous solution of titanium chloride and a nitrite ion-containing aqueous solution, a firing step in which heating to several hundred degrees Celsius is performed for crystallizing titanium oxide on a base material is not needed. Accordingly, it becomes possible to fix titanium oxide also to a material having low thermal resistance to high temperatures.

In addition, a titanium oxide film can be formed on a surface of a base material without using a binder, and thus, the function of titanium oxide can be imparted to the entire surface of the base material.

(2) Since this process is a titanium oxide film forming process using an immersion method, a large-scale film forming apparatus provided with a vacuum unit as used in a dry process is not needed. Also, it is not necessary to heat the base material itself.

(3) Since the thickness of the titanium oxide film on the base material increases as the immersion time increases, it becomes possible to easily control the thickness of the titanium oxide film by controlling the immersion time. Further, since the entire surface of the base material is immersed in the mixed liquid, the distribution of the film thickness is also relatively uniform.

Accordingly, a UV-shielding effect, an antifogging effect, an antifouling effect, and a photocatalytic effect, which are expected to be imparted to the glass having a titanium oxide film formed thereon, are uniformly exhibited in a region of the glass surface.

(4) A substance which is difficult to handle and has a safety problem such as ammonium fluorotitanate or titanium hydrofluoride is not used, and also, it is not necessary to additionally add an agent for supplementing fluorine ions.

In addition, since the mixed liquid of an aqueous solution of titanium chloride and a nitrite ion-containing aqueous solution to be used in the present invention is not corrosive unlike fluorine-based solvents, even if a structure made of a metal or the like is also disposed on the base material, such a structure made of a metal or the like is not corroded.

Further, since the titanium oxide film is not formed using a hydrolysis reaction, it is not necessary to set the temperature of the solution to a higher temperature than room temperature, and thus, a problem that the uniformity of the thickness of the titanium oxide film is deteriorated due to the effect of convection flow does not also occur.

(5) The titanium oxide film formed according to the present invention has a photocatalytic function attributed to an anatase-type titanium oxide film, and also has a property of high transparency attributed to a rutile-type titanium oxide film, and thus, even if a titanium oxide film is formed on the surface of a transparent material according to the present invention, the transparency can be maintained.

(6) The titanium oxide film formed according to the present invention is grown by a covalent bond between oxygen on the glass surface and a titanium ion, and therefore, unlike the case where titanium oxide is fixed to the glass surface by physical adsorption using a conventional wet process, even if the titanium oxide film is formed relatively thick, the titanium oxide film is fixed rigidly to the glass surface.

### BRIEF DESCRIPTION OF THE DRAWINGS

FIG. 1 is a view for explaining the outline of the present invention.

FIG. 2 is a view for explaining the cleavage of a siloxane bond and the introduction of a hydroxy group in Step 0.

FIG. 3 is a view (1) for explaining the formation of a titanium oxide film in Step 1.

FIG. 4 is a view (2) for explaining the formation of a titanium oxide film in Step 1.

FIG. 5 is a view (3) for explaining the formation of a titanium oxide film in Step 1.

FIG. 6 is a view (4) for explaining the formation of a titanium oxide film in Step 1.

FIG. 7 is a view (5) for explaining the formation of a titanium oxide film in Step 1.

FIG. 8 is a view (6) for explaining the formation of a titanium oxide film in Step 1.

FIG. 9 is a view (7) for explaining the formation of a titanium oxide film in Step 1.

FIG. 10 is a view (8) for explaining the formation of a titanium oxide film in Step 1.

FIG. 11 is a view showing a structural example of an excimer lamp.

FIG. 12 is a graph showing the radiation wavelength distribution of an excimer lamp.

FIG. 13 is a schematic view of an experimental system in which a base material is irradiated with vacuum ultraviolet light from an excimer lamp.

FIG. 14 is a graph showing that the wettability is improved by irradiation of a glass with ultraviolet light.

FIG. 15 is a graph showing the results of XPS measurement with respect to titanium oxide in samples subjected to Step 0 to Step 3 using three types of mixed liquids.

FIGS. 16A and 16B are views showing another structural example of a rare gas fluorescent lamp.

### DESCRIPTION OF THE PREFERRED EMBODIMENTS

1. Step 0 to Step 3 and their Effects

First, treatments in the respective steps according to the present invention will be described.

In the present invention, as described above, a base material, which is a molded product composed of a glass, is subjected to the following Step 0 to Step 3, whereby a titanium oxide film is formed on the molded product composed of a glass.

(Step 0): A surface of a molded product composed of a glass on which titanium oxide is fixed is irradiated with ultraviolet light in an air atmosphere containing oxygen and water.

(Step 1): The molded product is immersed in a mixed liquid of an aqueous solution of titanium chloride and a nitrite ion-containing aqueous solution (for example, an aqueous solution of sodium nitrite).

(Step 2): After the lapse of a predetermined time, the molded product is pulled out from the mixed liquid and washed. The washing is performed with pure water (for stopping the reaction).

(Step 3): The molded product after washing is dried at room temperature.

As described above, in Step 0, a surface of a molded product composed of a glass on which titanium oxide is fixed is irradiated with ultraviolet light in an air atmosphere containing oxygen and water.

It was confirmed that Step 0 adopted in the present invention has the following effects on the molded product composed of a glass.

(i) By irradiating a surface of the glass molded product with ultraviolet light, the surface of the molded product is activated. More specifically, a bond between a metal atom or the like and oxygen on the surface of the molded product is cleaved. For example, in the case of a general silicate glass, a siloxane bond is cleaved.

It is necessary to irradiate light which is absorbed by a glass and has a wavelength having an energy exceeding the activation energy of the glass as the light capable of cleaving such a siloxane bond. More specifically, when a surface of the molded product composed of a glass (silicate glass) is irradiated with vacuum ultraviolet light with a wavelength of 200 nm or less, a siloxane bond is cleaved on the surface of the molded product.

Incidentally, according to an experiment made by the present inventors, it was found that in order to reliably cleave a siloxane bond, it is preferred to irradiate a surface of the molded product with light with a wavelength of 180 nm or less.

(ii) Then, the activated surface of the molded product and hydrogen in water contained in the atmosphere are bound to each other, whereby a hydroxy end group is formed on the glass surface. That is, by the cleavage, oxygen (O) is exposed on the glass surface. This exposed oxygen is bound to hydrogen (H) in water contained in the atmosphere to form a hydroxy group. In other words, it is considered that an end group on the glass surface is converted to a hydroxy group in the end.

Then, it was confirmed that by applying the subsequent Steps 1, 2, and 3, a titanium oxide film having a uniform thickness is formed on the surface of the molded product. Here, in Step 1 in which the molded product (base material) is immersed in a mixed liquid of an aqueous solution of titanium chloride and a nitrite ion-containing aqueous solution, a heating procedure is not needed, and the step is performed at room temperature.

Incidentally, when vacuum ultraviolet light with a wavelength of 180 nm or less is irradiated, an additional effect that a dirt such as an organic substance adhered to the glass surface is decomposed is also remarkably obtained. Since this dirt such as an organic substance may be a reaction inhibitor which inhibits the reaction of forming a titanium oxide film in Step 1 described below, it is particularly preferred that in Step 0, vacuum ultraviolet light with a wavelength of 180 nm or less is irradiated.

A mechanism of fixing titanium oxide to a base material composed of a glass (a molded product composed of a glass) by the method for forming a titanium oxide film on a base material of the present invention is considered to be basically as follows.

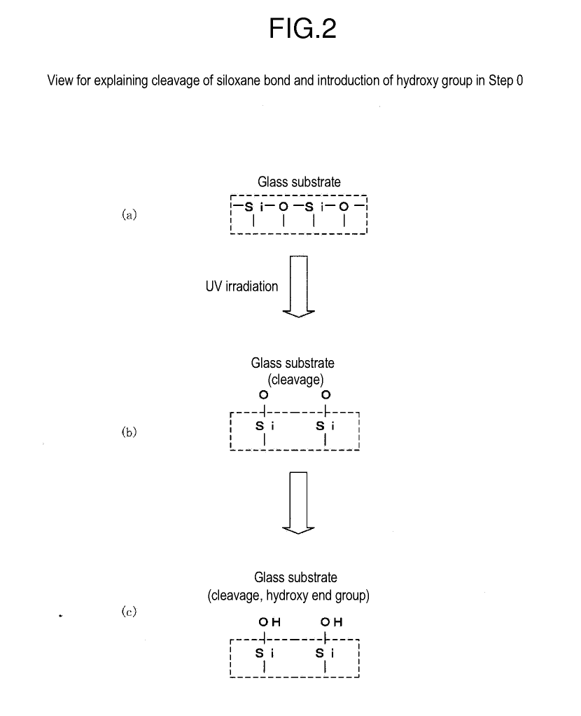

The cleavage of a bond between a metal atom or the like and oxygen and the formation of a hydroxy end group in Step 0 will be described with reference to FIG. 2. As an example of the glass, a silicate glass having a silicon dioxide backbone is taken as an example, however, the glass is not limited thereto.

In Step 0, a molded product composed of a glass (hereinafter, also referred to as “glass molded product”) is irradiated with light including ultraviolet light with a wavelength of 200 nm or less (more specifically, vacuum ultraviolet light (also referred to as “vacuum ultraviolet (VUV)”) with a wavelength of 180 nm or less) ((a)→(b) of FIG. 2). By doing this, as shown in (b) of FIG. 2, a bond between a metal atom or the like (silicon (Si) in the example shown in FIG. 2) and oxygen (O) is cleaved. Then, as shown in (c) of FIG. 2, it is considered that hydrogen from water in the air is introduced at the cleavage site, and in the end, an end group on the glass surface is converted to a hydroxy group.

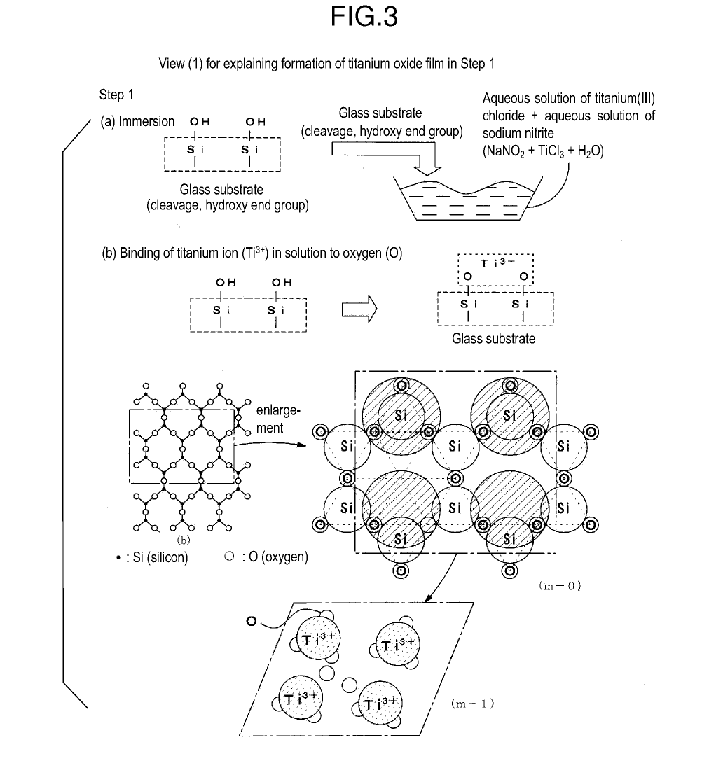

Next, with reference to FIG. 3 to FIG. 10, the formation of a titanium oxide film in Step 1 will be described.

In Step 1, as shown in (a) of FIG. 3, the glass molded product irradiated with VUV is immersed in a mixed liquid of an aqueous solution of titanium(III) chloride (an aqueous solution of TiCl₃) and an aqueous solution of sodium nitrite (an aqueous solution of NaNO₂). In the mixed liquid, a titanium ion (Ti³⁺) and a nitrite ion (NO²⁻) are contained.

As a result of the immersion, as shown in (b) of FIG. 3, hydrogen is detached from the hydroxy end group of the glass molded product and oxygen and a titanium ion in the mixed liquid is bound to each other.

Here, in order to facilitate understanding, silicon dioxide constituting the glass (silicate glass) is assumed to have a crystal structure like a rock crystal.

A schematic view in which oxygen and a titanium ion are bound to each other in the crystal structure is shown in (m-0) and (m-1) of FIG. 3. A shaded circle in (m-0) and (m-1) of FIG. 3 is a titanium atom (ion).

The experimental result described below shows that by performing the treatments in Step 0 to Step 3, a transparent (rutile-type) titanium oxide film was formed on the glass surface. Based on this experimental result, as shown in the schematic view of (m-1) of FIG. 3, it is considered that the titanium molecules bound to oxygen are distributed such that four titanium molecules are arranged in a rectangular shape.

That is, the distribution of the hydroxy end groups exposed on the glass surface resulting from the cleavage of a bond between silicon (Si) and oxygen (O) by the irradiation with VUV corresponds to the distribution of oxygen atoms exposed on the glass surface in the mixed liquid. Since a titanium ion is bound to this exposed oxygen atom, the arrangement of the titanium ions depends on the above-described distribution of the oxygen atoms.

The distribution of the titanium ions bound to oxygen is a distribution such that it corresponds to a bond distance of titanium oxide, and the titanium molecules are arranged in a tetragonal system with a rutile-type structure.

That is, the dominant molecular structure of a titanium oxide film formed by the method for forming a titanium oxide film of the present invention is a rutile-type structure.

As apparent from the schematic view of (m-1) of FIG. 3, on the surface of the glass (silicate glass) molded product in a state where the bond between silicon (Si) and oxygen (O) is cleaved by the irradiation with vacuum ultraviolet light in the air containing oxygen and water, four titanium atoms form a first stage of a cubic crystal system. Incidentally, in the rectangle composed of four titanium atoms, two oxygen atoms are distributed.

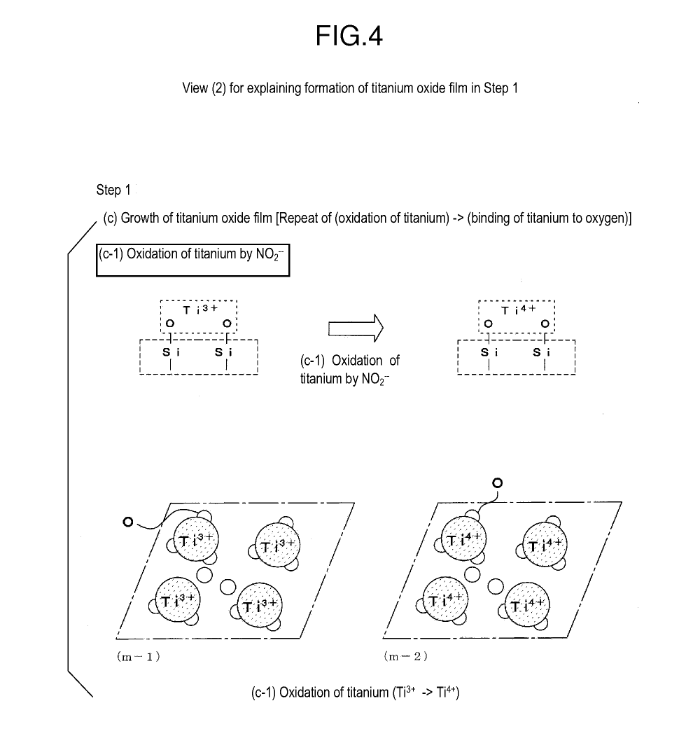

By the immersion described above, the titanium oxide film is grown as shown in FIG. 4 to FIG. 10 over time. That is, as shown in (c) of FIG. 4, [(oxidation of titanium)→(binding of titanium to oxygen)] are repeated.

First, as shown in (c-1) of FIG. 4, a titanium ion bound to oxygen in the glass molded product is oxidized by a nitrite ion coexisting with a titanium ion in the mixed liquid to convert Ti³⁺ to Ti⁴⁺ (see a schematic view of (m-2) of FIG. 4).

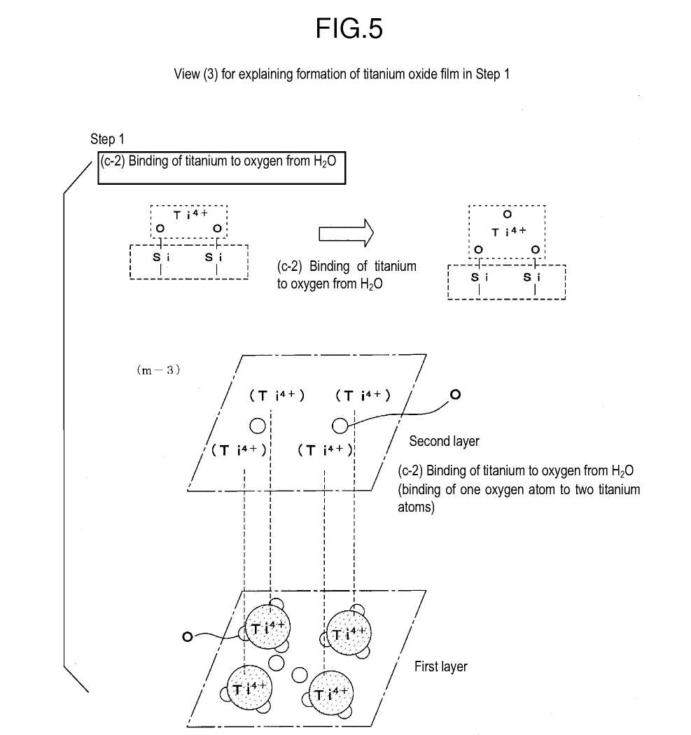

As shown in (c-2) of FIG. 5, this oxidized titanium ion is bound to oxygen supplied from water in the mixed liquid. The first stage of the cubic crystal system composed of a rectangle including four titanium atoms (titanium ions) and two oxygen atoms distributed in this rectangle shown in a schematic view of (m-3) of FIG. 5 is called “first layer” for the sake of convenience.

The binding between the titanium ion and the oxygen atom in (c-2) of FIG. 5 is achieved by binding one oxygen atom to two titanium ions in the first layer. Since there are four titanium ions in the first layer, the number of oxygen atoms bound thereto is 2. A region where two oxygen atoms are located is called “second layer” for the sake of convenience as shown in (m-3) of FIG. 5.

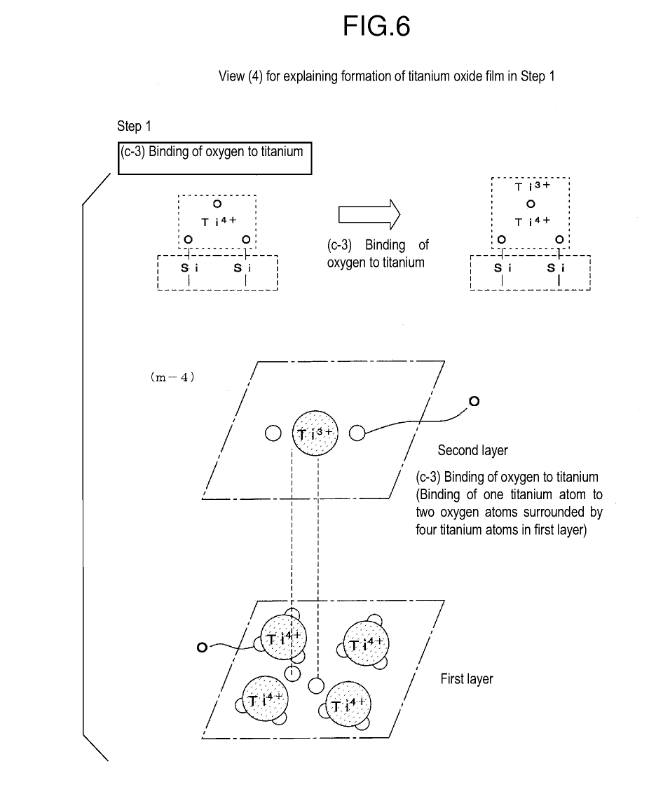

Next, as shown in (c-3) of FIG. 6, these oxygen atoms are bound to a titanium ion in the mixed liquid. More specifically, as shown in a schematic view of (m-4) of FIG. 6, the two oxygen atoms located in the first layer are bound to one titanium ion.

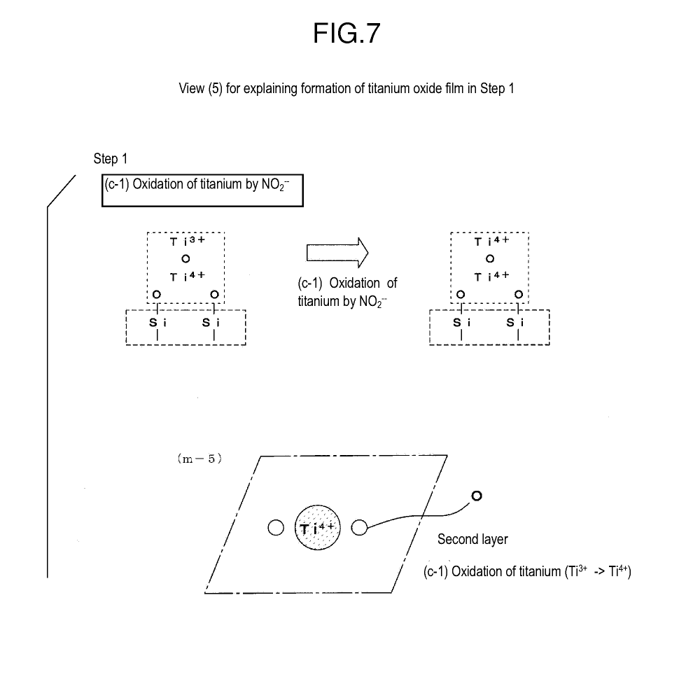

Then, as shown in (c-1) of FIG. 7 and a schematic view of (m-5) of FIG. 7, one titanium ion introduced as described above is oxidized by a nitrite ion to convert Ti³⁺ to Ti⁴⁺.

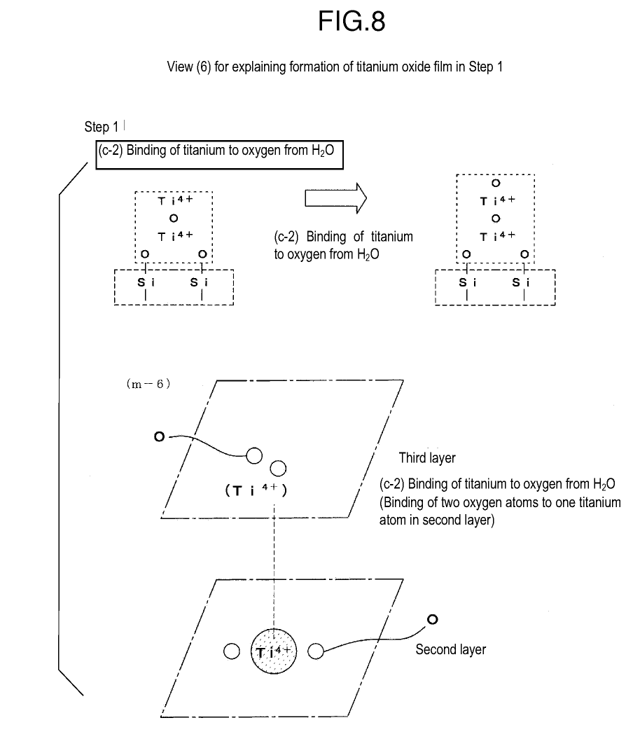

This oxidized titanium ion is bound to oxygen supplied from water in the mixed liquid as shown in (c-2) of FIG. 8.

More specifically, as shown in a schematic view of (m-6) of FIG. 8, two oxygen atoms are bound to one titanium ion in the second layer. A region where these two oxygen atoms are located is called “third layer” for the sake of convenience.

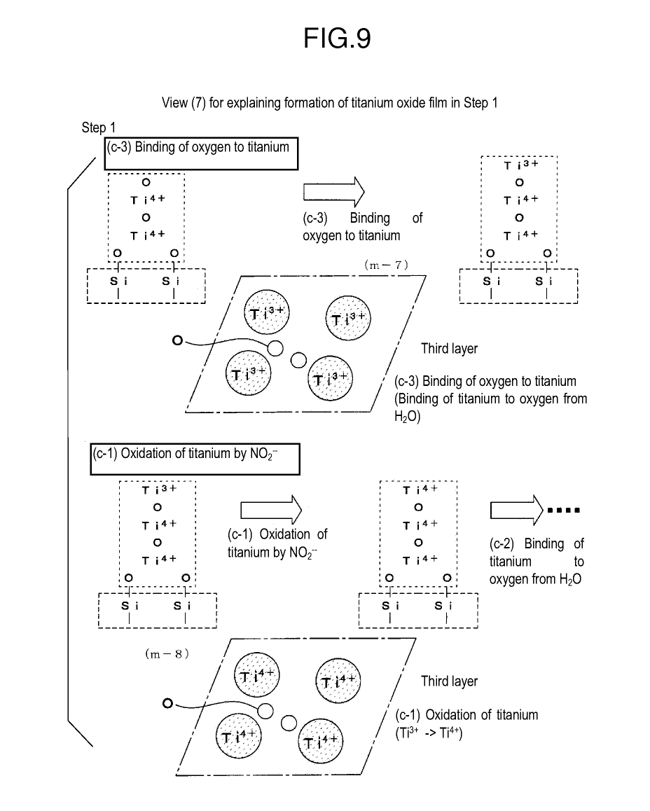

Then, as shown in (c-3) of FIG. 9, these oxygen atoms are bound to a titanium ion in the mixed liquid. More specifically, as shown in a schematic view of (m-7) of FIG. 9, the two oxygen atoms located in the third layer are bound to four titanium ions.

Then, as shown in (c-1) of FIG. 9 and a schematic view of (m-8) of FIG. 9, the four titanium ions are oxidized by a nitrite ion.

Thereafter, the above-described [(c-2) binding of the oxidized titanium ion to oxygen], [(c-3) binding of the bound oxygen to a titanium ion], and [(c-1) oxidation of a titanium ion by a nitrite ion] are carried out repeatedly.

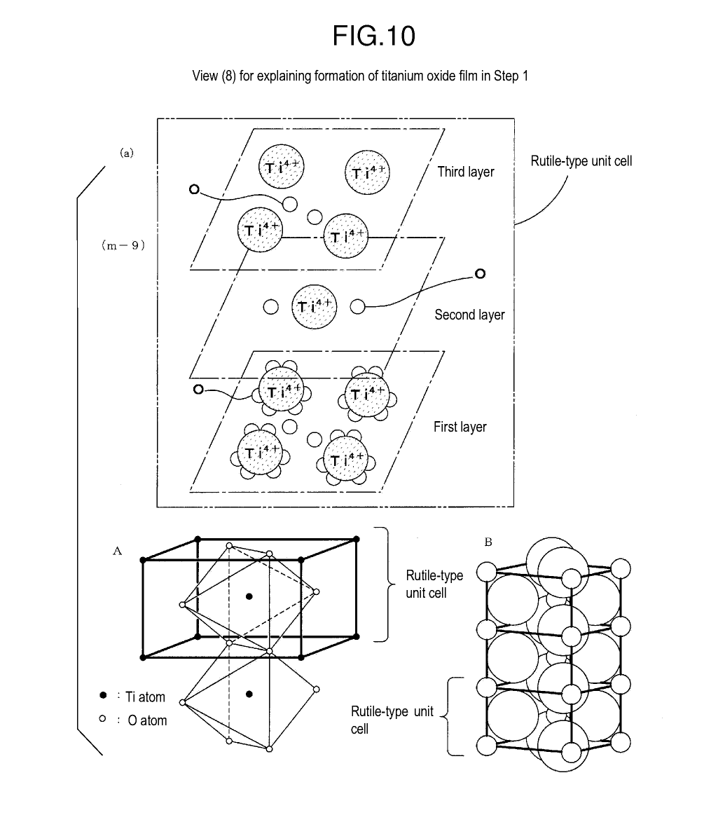

In a titanium oxide film shown in a schematic view of (m-9) of FIG. 10 which is grown by stacking the first layer, the second layer, and the third layer described above in this order, a rutile-type structure is dominant as shown in A and B of FIG. 10.

Due to this, the titanium oxide film formed according to the present invention shows high transparency, absorbs almost no light in a wavelength range of 300 to 700 nm, and thus exhibits extremely high transparency.

As described above, in Step 1, it is considered that a titanium oxide film is grown on the VUV-irradiated surface of the glass molded product by repeating (c-1) oxidation of a titanium ion by a nitrite ion, (c-2) binding of the oxidized titanium ion to oxygen, and (c-3) binding of the bound oxygen to a titanium ion at the end of the cleaved siloxane bond on the surface of the glass molded product.

That is, it is considered that titanium oxide is formed according to the following reaction formula in a VUV-irradiated region on the surface of the glass molded product immersed in the mixed liquid of an aqueous solution of titanium(III) chloride (an aqueous solution of TiCl₃) and an aqueous solution of sodium nitrite (an aqueous solution of NaNO₂).

3Ti⁺³+6H₂O→3TiO₂+12H⁺+3e⁻

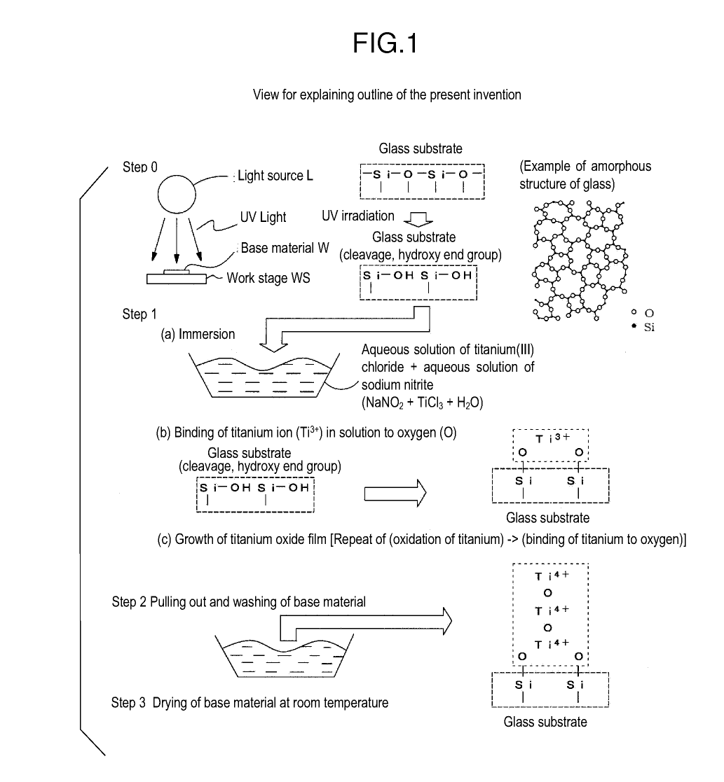

Incidentally, in the formation of a titanium oxide film in Step 1 described with reference to FIG. 3 to FIG. 10, as described above, silicon dioxide constituting the glass (silicate glass) is assumed to have a crystal structure like a rock crystal. In fact, as shown in FIG. 1, the glass has an amorphous structure and silicon atoms and oxygen atoms are irregularly arranged.

As described above, it is considered that the crystal structure of titanium oxide formed on the glass molded product is determined according to the position of oxygen present on the surface of the glass molded product. Therefore, when silicon dioxide constituting the glass (silicate glass) forms a crystal structure like a rock crystal, the distribution of titanium ions bound to oxygen atoms exposed on the surface is a distribution such that the crystal structure of the growing titanium oxide film is a tetragonal system with a rutile-type structure. However, in a glass having an amorphous structure, the arrangement of the oxygen atoms exposed on the glass surface (that is, the distribution of the titanium ions bound to oxygen) by performing Step 0 is not necessarily a distribution such that the crystal structure of the growing titanium oxide film is a tetragonal system with a rutile-type structure.

It is considered that anatase-type titanium oxide is formed in a region where the arrangement of the oxygen atoms exposed on the surface and the arrangement (distance) of the titanium ions bound to the oxygen atoms are substantially the same as the lattice constant of anatase-type titanium oxide.

That is, it is considered that in the titanium oxide film formed on the surface of the glass molded product having an amorphous structure, rutile-type titanium oxide and anatase-type titanium oxide are intermingled with each other.

After the glass molded product is immersed in the mixed liquid for a predetermined time as described above, in Step 2, the molded product is pulled out from the mixed liquid and washed with pure water or the like to stop the reaction.

The thickness of the titanium oxide film on the base material increases as the immersion time in the mixed liquid increases, however, by pulling out the base material from the mixed liquid and washing the base material, the reaction of forming the titanium oxide film is stopped. It is considered that by controlling this immersion time, the thickness of the titanium oxide film can be controlled.

In Step 3, the base material after washing is dried at room temperature.

By forming the titanium oxide film as described above, the following advantageous effects can be obtained.

(1) Since a firing step in which heating to several hundred degrees Celsius is performed for crystallizing titanium oxide on a base material is not needed, it becomes possible to fix titanium oxide also to a material having low thermal resistance to high temperatures.

(2) In addition, a titanium oxide film can be formed on a surface of a base material without using a binder, and thus, the function of titanium oxide can be imparted to the entire surface of the base material.

(3) Since this process is a titanium oxide film forming process using an immersion method, a large-scale film forming apparatus provided with a vacuum unit as used in a dry process is not needed. Also, it is not necessary to heat the base material itself.

(4) It is considered that a titanium oxide film is formed on a base material by repeatedly carrying out oxidation of titanium (c-1), binding of the oxidized titanium to oxygen (c-2), and binding of the bound oxygen to titanium (c-3) as previously described with reference to FIG. 2 to FIG. 10. That is, the thickness of the titanium oxide film on the base material increases as the immersion time increases, and therefore, by controlling the immersion time, the thickness of the titanium oxide film can be easily controlled. That is, by washing the surface with water to stop the reaction of forming the titanium oxide film as in Step 2, the thickness of the titanium oxide film is controlled. Further, since the entire surface of the base material is immersed in the mixed liquid, the distribution of the film thickness is also relatively uniform. Accordingly, a UV-shielding effect, an antifogging effect, an antifouling effect, and a photocatalytic effect, which are expected to be imparted to the glass having a titanium oxide film formed thereon, are uniformly exhibited in a region of the glass surface.

(5) Further, it is not necessary to use a substance which is difficult to handle and has a safety problem such as ammonium fluorotitanate or titanium hydrofluoride, and also, it is not necessary to additionally add an agent for supplementing fluorine ions. In addition, since the titanium oxide film is not formed using a hydrolysis reaction, it is not necessary to set the temperature of the solution to a higher temperature than room temperature, and thus, a problem that the uniformity of the thickness of the titanium oxide film is deteriorated due to the effect of convection flow does not also occur.

(6) As described above, since the mixed liquid of an aqueous solution of titanium chloride and a nitrite ion-containing aqueous solution to be used in the present invention is not corrosive unlike fluorine-based solvents, even if a structure made of a metal or the like is also disposed on the base material, such a structure made of a metal or the like is not corroded.

(7) The titanium oxide film formed according to the present invention is grown by a covalent bond between oxygen on the glass surface and a titanium ion, and therefore, unlike the case where titanium oxide is fixed to the glass surface by physical adsorption using a conventional wet process, even if the titanium oxide film is formed relatively thick, the titanium oxide film is fixed rigidly to the glass surface.

(8) The titanium oxide film formed according to the present invention has a photocatalytic function attributed to an anatase-type titanium oxide film as described below, and also has a property of high transparency attributed to a rutile-type titanium oxide film, and thus, even if a titanium oxide film is formed on the surface of a transparent material, the transparency can be maintained.

(9) Further, since this process is a chemical process, a titanium oxide film can be formed also on a surface of a fine structure of a glass molded product.

2. Specific Examples of the Invention

Hereinafter, specific embodiments of the present invention will be described in detail, however, the present invention is by no means limited to the following embodiments, and can be carried out by appropriately adding modifications within the scope of the object of the present invention. Incidentally, the description of overlapping portions is sometimes omitted as needed, however, there is no intention to limit the gist of the present invention.

[Molded Product]

The molded product composed of a glass is produced by molding a glass using a known method. Examples of the known molding method include a press-molding method in which a glass is casted into a mold and then solidified.

The shape of the molded product composed of a glass is not particularly limited. For example, the molded product may be a general-purpose product such as a film, a sheet, a tube, a pipe, or a bottle, and also may be a molded product designed according to a specific application such as a plastic substrate for use in a microflow device.

Hereinafter, with respect to the embodiments of the present invention, (a) Step 0, in which a surface of a glass molded product is irradiated with ultraviolet light to activate the surface of the molded product, and (b) Steps 1, 2, and 3, in which the molded product (base material) subjected to a surface treatment in Step 0 is immersed in a mixed liquid of an aqueous solution of titanium chloride and an aqueous solution of sodium nitrite which is a nitrite ion-containing aqueous solution, after the lapse of a predetermined time, the base material is pulled out from the mixed liquid and washed, and then, the base material after washing is dried at room temperature will be sequentially described.

[Step 0]

Step 0 is a step in which a surface of a glass molded product is irradiated with ultraviolet light. By the irradiation of the surface with ultraviolet light, the surface is activated.

As a light source, for example, an excimer lamp which emits vacuum ultraviolet light with a center wavelength of 172 nm is used.

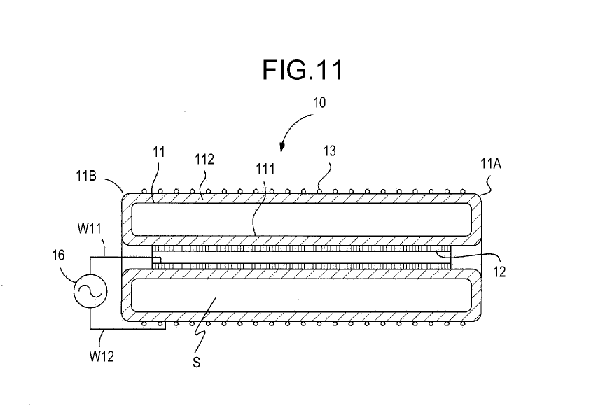

FIG. 11 is a view showing a structural example of the excimer lamp. The excimer lamp has a tubular structure, and FIG. 11 shows a cross-sectional view taken along a plane including the tube axis. An excimer lamp 10 has a vessel (arc tube) 11 having a substantially double-tube structure in which an inner tube 111 and an outer tube 112 are substantially concentrically arranged, and by sealing both end portions 11A and 11B of this vessel 11, a cylindrical discharge space S is formed therein. In the discharge space S, a rare gas such as xenon, argon, or krypton is entrapped. The vessel 11 is made of a quartz glass. On an inner peripheral surface of the inner tube 111, an inner electrode 12 is provided, and on an outer peripheral surface of the outer tube 112, a grid-shaped outer electrode 13 is provided. These electrodes 12 and 13 are disposed with the vessel 11 and the discharge space S interposed therebetween. To the electrodes 12 and 13, a power supply 16 is connected through lead wires W11 and W12. When a high-frequency voltage is applied by the power supply 16, electric discharge (so-called dielectric barrier discharge) with dielectric bodies (111 and 112) interposed between the electrodes 12 and 13 is formed, and in the case of xenon gas, vacuum ultraviolet light with a center wavelength of 172 nm is generated, and the vacuum ultraviolet light is emitted to the outside.

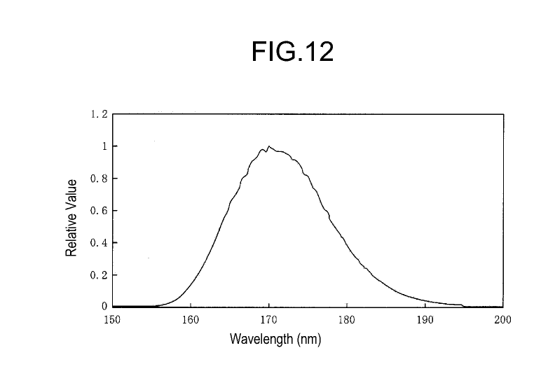

FIG. 12 shows a radiation wavelength distribution when the excimer lamp 10 shown in FIG. 11 was turned on at a frequency of 20 KHz and a bulb wall load of 0.1 W/cm². The abscissa represents a radiation wavelength, and the ordinate represents a relative value to the intensity of light with a wavelength of 170 nm.

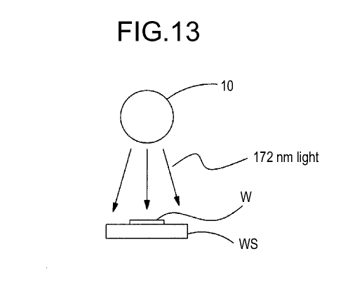

FIG. 13 shows a schematic view of an experimental system. As shown in FIG. 13, a base material W on a work stage WS was irradiated with vacuum ultraviolet light from an excimer lamp 10. As the excimer lamp 10, an excimer lamp which emits vacuum ultraviolet light with a center wavelength of 172 nm as described above was used, and an irradiance on the surface of a sample was 20 mW/cm².

The sample was a molded product obtained by molding using a silicate glass, and was a substrate whose shape was a square with a thickness of 10 mm, a length of 100 mm, and a width of 100 mm.

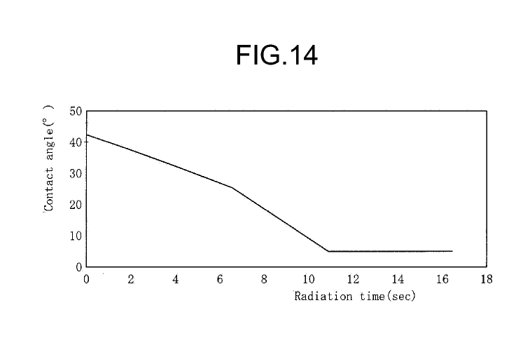

FIG. 14 is a graph showing a manner that the wettability is improved when a glass is irradiated with ultraviolet light. In FIG. 14, the abscissa represents a UV radiation time (sec), and the ordinate represents a contact angle)(° of water on the glass. FIG. 14 shows the data when an alkali-free glass was irradiated with ultraviolet light with a wavelength of 172 nm from a standard output excimer lamp (10 mW/cm²) at an irradiation distance of 2 mm.

As shown in FIG. 14, by irradiating the glass with ultraviolet light, the contact angle (°) of water on the glass is decreased, and the wettability is improved. The reason why the wettability is improved is considered to be that by irradiating the glass with ultraviolet light, the glass surface is activated and an end group on the activated surface is converted to a hydroxy group (OH group).

By summarizing the above results, it is considered that a treatment of a surface of a glass molded product in Step 0 in which a surface of a glass molded product is irradiated with ultraviolet light (vacuum ultraviolet light) activates the surface and converts an end group on the activated surface to a hydroxy group. Based on the data, it is considered that according to Step 0, as the activation of the surface, more specifically, a bond between a metal atom or the like and oxygen on the surface is cleaved, and also hydrogen is introduced from water in the air at the cleavage site, and in the end, an end group on the glass surface is converted to a hydroxy group.

[Step 1], [Step 2], and [Step 3]

Next, Steps 1, 2, and 3 Will be Described.

Step 1 is a step in which the base material which is the glass molded product having a surface irradiated with ultraviolet light (vacuum ultraviolet light) in Step 0 is immersed in a mixed liquid of an aqueous solution of titanium chloride and a nitrite ion-containing aqueous solution. Step 2 is a step in which after the lapse of a predetermined time, the base material is pulled out from the mixed liquid and washed, and Step 3 is a step in which the base material after washing is dried at room temperature.

The base material used is a molded product obtained by molding using a silicate glass and is a substrate whose shape is a square with a thickness of 2 mm, a length of 8 mm, and a width of 8 mm.

This base material was irradiated with vacuum ultraviolet light from an excimer lamp which emits vacuum ultraviolet light with a center wavelength of 172 nm for 1 to 2 minutes. An irradiance on the irradiated surface of the base material was 4 to 5 mW/cm² or less.

Subsequently, as Steps 1, 2, and 3, the above base material was immersed in a mixed liquid of an aqueous solution of titanium (III) chloride having a titanium (III) chloride concentration of 20% to 10 mM and an aqueous solution of sodium nitrite having a sodium nitrite concentration of 0.1 M. As the mixed liquid in which the base material was immersed, three types of mixed liquids in which the hydrogen-ion exponent was adjusted as follows: pH=7, pH=8.5, and pH=10 were used. Incidentally, the adjustment of the pH to 8.5 was performed by introducing calcium acetate into the mixed liquid. In the same manner, the adjustment of the pH to 10.0 was performed by introducing calcium acetate and sodium hydroxide into the mixed liquid. After the lapse of 30 minutes from the initiation of immersion, the base material was pulled out from the mixed liquid, washed with pure water, and then dried at room temperature.

In order to examine the state of the surface of the sample subjected to Steps 1, 2, and 3, by using an X-ray photoelectron spectroscope (XPS), XPS-7000 manufactured by Rigaku Corporation, XPS measurement was performed for the surface.

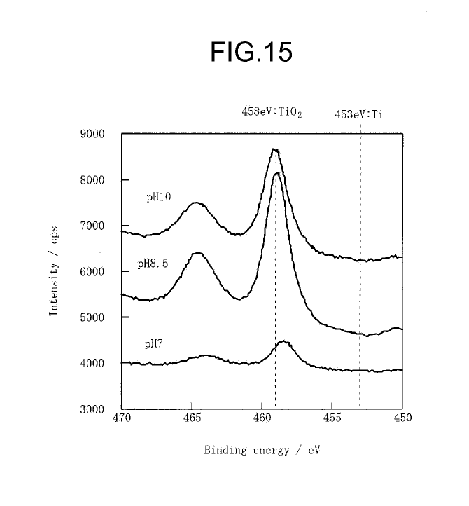

The results of the XPS measurement are shown in FIG. 15. In any of the cases of the base materials immersed in the mixed liquids at the respective pH values, a peak at around 453 eV attributed to titanium (Ti) was not observed, however, a peak at around 458 eV attributed to titanium oxide (TiO₂) was observed. From these results, it was confirmed that what was fixed to the surface of each of the base materials was titanium oxide.

That is, by performing the treatments in Steps 1, 2, and 3, a titanium oxide film was formed on the surface of the molded product composed of the silicate glass subjected to the treatment in Step 0.

[Crystal Structure]

A glass (silicate glass) has an amorphous structure, and silicon atoms and oxygen atoms are irregularly arranged. As described above, the crystal structure of titanium oxide formed on the glass molded product is considered to be determined according to the position of oxygen present on the surface of the glass molded product. Therefore, it is considered that the arrangement of the oxygen atoms exposed on the glass surface (that is, the distribution of the titanium ions bound to oxygen) by performing Step 0 is such that in some regions, the oxygen atoms are distributed so that the crystal structure of the growing titanium oxide film is a rutile-type structure, and in other regions, the oxygen atoms are distributed so that the an anatase-type titanium oxide film is formed.

That is, it is considered that in the titanium oxide film formed on the surface of the glass molded product having an amorphous structure, rutile-type titanium oxide and anatase-type titanium oxide are intermingled with each other.

[Hydrophilicity]

Subsequently, with respect to three types of glass molded products subjected to the treatments in Step 0 to Step 3 using each of the above-described three types of mixed liquids so as to form a titanium oxide film on the surfaces of the glass molded products, a contact angle on the titanium oxide film-formed surface of each molded product was measured. As Comparative Example, a contact angle on the surface of the glass molded product before forming the titanium oxide film on the surface thereof was measured. As a liquid used in the measurement of the contact angle, water was adopted.

The contact angle on the surface of the glass molded product before forming the titanium oxide film on the surface thereof was about 60°. On the other hand, the contact angles on the titanium oxide film-formed surfaces of the three types of glass molded products were all less than 10°. That is, when a titanium oxide film is formed on the surface of the glass molded product using the method for forming a titanium oxide film of the present invention, the titanium oxide film-formed surface becomes a hydrophilic surface.

[Absorbance]

Absorbance wavelength characteristics were examined for three types of glass molded products subjected to the treatments in Step 0 to Step 3 using each of the above-described three types of mixed liquids so as to form a titanium oxide film on the surfaces of the glass molded products. As Comparative Example, absorbance wavelength characteristics were examined for the glass molded product before forming the titanium oxide film on the surface thereof.

In the measurement, an absorption spectrophotometer (model U-3310) manufactured by Hitachi High-Technologies Corporation was used.

As a result, it was found that the absorbance characteristics of all the three types of glass molded products did not change between before and after forming the titanium oxide film in a wavelength range of 300 to 700 nm. That is, it was found that the formed titanium oxide film absorbs almost no light in a wavelength range of 300 to 700 nm.

It is known that titanium oxide generally exhibits high transparency in a visible light range when it has a particle size in the order of nanometer. Therefore, it is presumed that the thickness of the titanium oxide film formed on the surface of the glass molded product this time is in the order of nanometer.

Incidentally, as the time for immersing in the mixed liquid of an aqueous solution of titanium chloride and a nitrite ion-containing aqueous solution is increased, the thickness of a titanium oxide film formed on the surface of the glass molded product is increased depending on the time. In our experiment, it was found that the immersion time is preferably 30 minutes or less when transparency in a wavelength range of 300 to 700 nm is maintained.

The titanium oxide film formed on the glass according to the present invention is a crystallized film in which a rutile-type titanium oxide film and an anatase-type titanium oxide film are intermingled with each other, and therefore, the adhesiveness between the glass and the titanium oxide film is stable.

In general, a rutile-type titanium oxide film has higher transparency with respect to light with a wavelength of 300 nm or less than an anatase-type titanium oxide film.

In the titanium oxide film according to the present invention, a rutile-type titanium oxide film and an anatase-type titanium oxide film are intermingled with each other, and therefore, it has a photocatalytic function attributed to the anatase-type titanium oxide film, and also has a property of high transparency attributed to the rutile-type titanium oxide film, and thus, for example, its applicability (such as application thereof to automobile windshields) is considered to be high.

Here, in the above-described example, an excimer lamp was used as a light source which emits vacuum ultraviolet light, but it is not limited thereto, and for example, a rare gas fluorescent lamp can also be used.

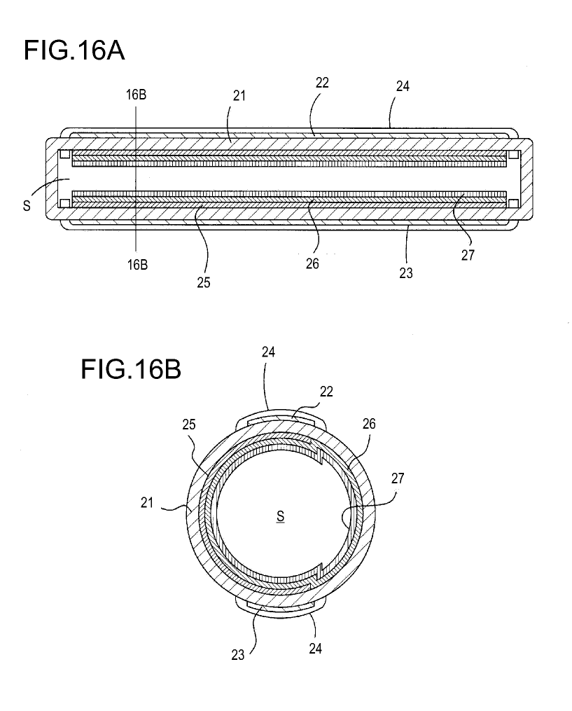

In FIGS. 16A and 16B, another structural example of a rare gas fluorescent lamp is shown. FIG. 16A shows a cross-sectional view taken along a plane including a tube axis, and FIG. 16B shows a cross-sectional view taken along the line 16B-16B of FIG. 16A. In FIGS. 16A and 16B, a lamp 20 has a pair of electrodes 22 and 23, the electrodes 22 and 23 are disposed on an outer peripheral surface of a vessel (arc tube) 21, and on the outer side of the electrodes 22 and 23, a protective film 24 is provided. An ultraviolet reflective film 25 is provided on the inner surface opposite to the light-emitting side of the inner peripheral surface of the vessel 21 (see FIG. 16B), and on the inner peripheral surface thereof, a low softening point glass layer 26 is provided. On the inner peripheral surface of this low softening point glass layer 26, a phosphor layer 27 is provided. The other structure is the same as that shown in FIG. 11, and a gas to be entrapped in a discharge space S in the vessel 21, and a phosphor to be used in the phosphor layer 27 are also the same as those described with reference to FIG. 11.

When a high-frequency voltage is applied to the electrodes 22 and 23, dielectric barrier discharge is formed between the electrodes 22 and 23, and ultraviolet light is generated as described above. Due to this, the phosphor is excited and light is generated from the phosphor layer. By suitably selecting the phosphor, for example, ultraviolet light with a center wavelength of around 190 nm is generated from the phosphor layer. This light is reflected by the ultraviolet reflective film 25 and emitted to the outside from an opening portion where the ultraviolet reflective film 25 is not provided.

Further, in the case where a region which is irradiated with vacuum ultraviolet light on the surface of the molded product is small, it is also possible to use a deuterium lamp which emits light in a wavelength range including a vacuum ultraviolet wavelength.

Incidentally, in the above example, in Step 0, a hydroxy group (OH group) is introduced on the glass surface and also in order to remove a dirt such as an organic substance to become a reaction inhibitor which inhibits a reaction of forming a titanium oxide film, the glass surface is irradiated with light including vacuum ultraviolet light with a wavelength of 200 nm or less in an air atmosphere containing oxygen and water, however, the same effect can also be obtained by another method.

For example, in the case where a glass immersed in an acidic solution such as hydrofluoric acid (HF), a hydrogen peroxide solution, or a mixed acid (for example, a liquid obtained by mixing sulfuric acid and nitric acid at a volume ratio of 3:1) or an alkaline solution such as an aqueous solution of sodium hydroxide, the same effect can also be obtained.

Further, by subjecting the glass surface to a plasma discharge treatment (for example, an atmospheric-pressure plasma treatment) in an air atmosphere, the same effect can also be obtained.

However, in the case where an immersion step in an acidic solution or an alkaline solution or an atmospheric-pressure plasma treatment step is adopted, an activity of damaging the glass surface is exhibited along with an activity of introducing an OH group on the glass surface and an activity of removing a reaction inhibitor so that the glass surface is damaged to roughen the surface state. Accordingly, as the step adopted in Step 0, it is preferred to adopt a step of irradiating the glass surface with light including vacuum ultraviolet light with a wavelength of 200 nm or less in an air atmosphere containing oxygen and water.

What is claimed is:

1. A method for forming a titanium oxide film on a surface of a molded product composed of a glass, comprising:
introducing a hydroxy group on a surface of a molded product composed of a glass and also removing a reaction inhibitor which remains on the surface and inhibits the formation of a titanium oxide film; and
immersing the molded product in a mixed liquid of an aqueous solution of titanium chloride and a nitrite ion-containing aqueous solution.

2. The method for forming a titanium oxide film on a surface of a molded product composed of a glass according to claim 1, wherein in the introduction of a hydroxy group and the removal of a reaction inhibitor, a surface of a molded product composed of a glass is irradiated with light including vacuum ultraviolet light with a wavelength of 200 nm or less in an air atmosphere containing oxygen and water, and the molded product is immersed in a mixed liquid of an aqueous solution of titanium chloride and a nitrite ion-containing aqueous solution.

3. The method for forming a titanium oxide film on a surface of a molded product composed of a glass according to claim 1, wherein after the lapse of a predetermined time from the initiation of immersion of the molded product in the mixed liquid, the molded product is pulled out from the mixed liquid, washed with water to stop the film forming process, and then, the molded product after washing with water is dried at room temperature.
